(19) United States
(12) Patent Application Publication
(10) Pub. No.: US 2002/0185984 A1
(43) Pub. Date: Dec. 12, 2002

(54) Electric drive

(75) Inventors: Matthias Gold, Bad Urach (DE); Dirk Herke, Nuertingen (DE); Frank Hoenig, Deizisau (DE)

Correspondence Address: LAW OFFICE OF BARRY R LIPSITZ, 755 MAIN STREET, MONROE, CT, 06468, US

(73) Assignee: AFL Germany Electronics GmbH, Frickenhausen (DE)

(21) Appl. No.: 10/140,354

(22) Filed: May 6, 2002

Related U.S. Application Data
(63) Continuation of application No. PCT/EP01/09920, filed on Aug. 29, 2001.

(30) Foreign Application Priority Data
Sep. 7, 2000 (DE) 100 44 065.7

(51) Int. Cl. H02P 1/00

(52) U.S. Cl. 318/17

(57) ABSTRACT

The invention relates to an electric drive, in particular, for a fan of a motor vehicle, comprising an electric drive motor and an electronic control unit for controlling the drive motor. The drive motor comprises a commutator and associated power supply devices rubbing on the commutator, and the control unit comprises an electronic module arranged on a printed circuit board. In order to design the electric drive so that it is of simpler construction and more cost-effective to assemble, it is proposed that the drive motor and the control unit be arranged in a common housing, with the power supply devices held on the printed circuit board. The invention also relates to an electric fan with an electric drive of this kind.

The present disclosure relates to the subject matter disclosed in international application No. PCT/EP01/09920 of Aug. 29, 2001, which is incorporated herein by reference in its entirety and for all purposes.

### BACKGROUND OF THE INVENTION

The invention relates to an electric drive, in particular, for a fan of a motor vehicle, comprising an electric drive motor and a control unit for controlling the drive motor, the drive motor comprising a commutator and power supply devices rubbing on the commutator, and the control unit comprising a printed circuit board.

The invention also relates to an electric fan, in particular, for motor vehicles, comprising an electric drive of this kind and a fan wheel drivable by the drive motor.

Electric drives of the aforementioned kind are used, in particular, in motor vehicles for driving electric fans which interact with a radiator unit of the motor vehicle. Here the drive motor is usually assembled together with a fan wheel to form a constructional unit, while the control unit is connected via electric connection cables to the drive motor and is arranged in a separate housing at a distance from the drive motor. The control unit enables power-controlled control of the drive motor, to which end it usually comprises an electronic power device with at least one semiconductor switch operative in a load current circuit, as a rule, an FET output stage switch, for switching a supply current for the drive motor, and an electronic control device for controlling the semiconductor switch. The electronic power device and the electronic control device are held as a common electronic module on the printed circuit board. Such control units are known, for example, from German laid-open print DE 197 02 949 A1.

The object of the present invention is to further develop an electric drive of the kind mentioned at the outset so that it is of simpler constructional design and is more cost-effective to assemble.

### SUMMARY OF THE INVENTION

This object is accomplished in an electric drive of the generic kind, in accordance with the invention, in that the drive motor and the control unit are arranged in a common housing, and the power supply devices are held on the printed circuit board.

In accordance with the invention, the control unit and the drive motor form a constructional unit and, to this end, are arranged in a common housing. Such a compact arrangement has a significantly lower space requirement than is the case with standard fan drives which are made up of several single components. In addition, the inventive construction is characterized by very good electromagnetic compatability since the electronic power device of the control unit is arranged immediately adjacent to the drive motor and is surrounded together with the drive motor by the housing, which reliably prevents emission of electromagnetic interference. In particular, a separate power supply line between the control unit and the drive motor is dispensed with in the electric drive. This power supply line is a main cause of electromagnetic interference. The handling of the electric drive is also considerably facilitated. Moreover, the design of the electric drive as a constructional unit results in lower susceptibility.

The electric drive motor is designed as a commutator motor with a commutator (for current reversal). The commutator is held in the usual way on a rotating armature of the drive motor. Held on the commutator so as to rub thereon are power supply devices which are fixed accordingly on a stationary stator of the drive motor inside the housing. In accordance with the invention, provision is made for the power supply devices to be held on the printed circuit board which accommodates the electronic module of the control unit. This results in a particularly compact design and in improved dissipation of the heat occurring at the power supply devices, whereby the temperature of the power supply devices is reduced and their service life thereby considerably prolonged.

A further advantage of the design according to the invention resides in the arrangement of the power supply devices on the printed circuit board of the control unit enabling a short connection, in particular, between the electronic power device of the control unit and the power supply devices. This results in an improved efficiency of the overall system. The short connection between the control unit and the power supply devices also brings about improved electromagnetic compatibility as the length of the energy emitting and receiving connection lines is shortened.

The electric drive according to the invention is also characterized by lower manufacturing costs, as a separate holder for the power supply devices can be dispensed with. Assembly of the electric drive is also thereby simplified.

In a particularly preferred embodiment, provision is made for the control unit to comprise a heat sink which is thermally coupled with the power supply devices. Herein the heat sink not only assumes the task of dissipating the heat occurring, in particular, at the electronic power device of the control unit into the environment, but, at the same time, serves to cool the power supply devices which are thermally coupled with the heat sink. The coupling may be effected via the printed circuit board of the control unit which rests against both the heat sink and the power supply devices.

The heat sink preferably comprises several cooling elements arranged at an air vent of the housing, and a holding element to which the printed circuit board is secured. When the electric drive is used in a fan, in particular, for a motor vehicle, provision may be made for a flow of cooling air generated by the fan to pass through the air vent at which the cooling elements of the heat sink are held, so that a particularly effective heat dissipation is ensured.

It is expedient for the holding element of the heat sink to surround the printed circuit board in the shape of a ring as a particularly effective heat dissipation is thereby ensured.

A particularly space-saving design is advantageously obtained by the printed circuit board surrounding the motor shaft of the electric drive motor in a circumferential direction. Here it has proven particularly expedient for the printed circuit board to be of approximately circular ring-shaped design.

In a particularly preferred embodiment of the electric drive according to the invention, provision is made for the printed circuit board to form together with the power supply devices and the heat sink a constructional unit designed for independent handling. Assembly of the electric drive is considerably simplified by such a design, as it is merely necessary to assemble the drive motor and the aforementioned constructional unit together in a housing. In particular, this enables pre-assembly of the constructional unit comprising the printed circuit board with the electronic module arranged thereon, the power supply devices and the heat sink.

The power supply devices are preferably designed as carbon brushes. Alternatively, copper wire netting could, for example, also be used for the power supply devices.

It has proven particularly advantageous to arrange each of the carbon brushes displaceably on a carbon brush holder which is secured to the printed circuit board.

As mentioned hereinabove, the electric drive according to the invention is suited, in particular, for use in an electric fan, preferably for motor vehicles. Here the fan comprises a fan wheel which can be set in rotation by the drive motor. Herein it has proven particularly expedient for a flow of cooling air to be generated by the fan wheel inside the housing and to act upon the printed circuit board and the power supply devices held thereon.

For example, provision may be made for the housing to comprise an air outlet opening adjacent to the fan wheel and an air inlet opening at a distance from the air outlet opening, with a negative pressure being generatable by the fan wheel in the area of the air outlet opening and a suction current forming from the air inlet opening to the air outlet opening inside the housing. It is preferable for the printed circuit board with the power supply devices held thereon to be arranged adjacent to the air inlet or air outlet opening. In particular, an arrangement in the area of the air inlet opening has proven particularly advantageous for achieving good heat dissipation.

The following description of a preferred embodiment of the invention serves in conjunction with the drawings for more detailed explanation.

### BRIEF DESCRIPTION OF THE DRAWINGS

FIG. 1 is a diagrammatic sectional view of an electric fan for a motor vehicle with an electric drive; and

FIG. 2 is a perspective representation of a module of the electric drive which is designed for independent handling and comprises a heat sink with a printed circuit board secured thereto and carbon brushes held on the printed circuit board.

### DETAILED DESCRIPTION OF THE INVENTION

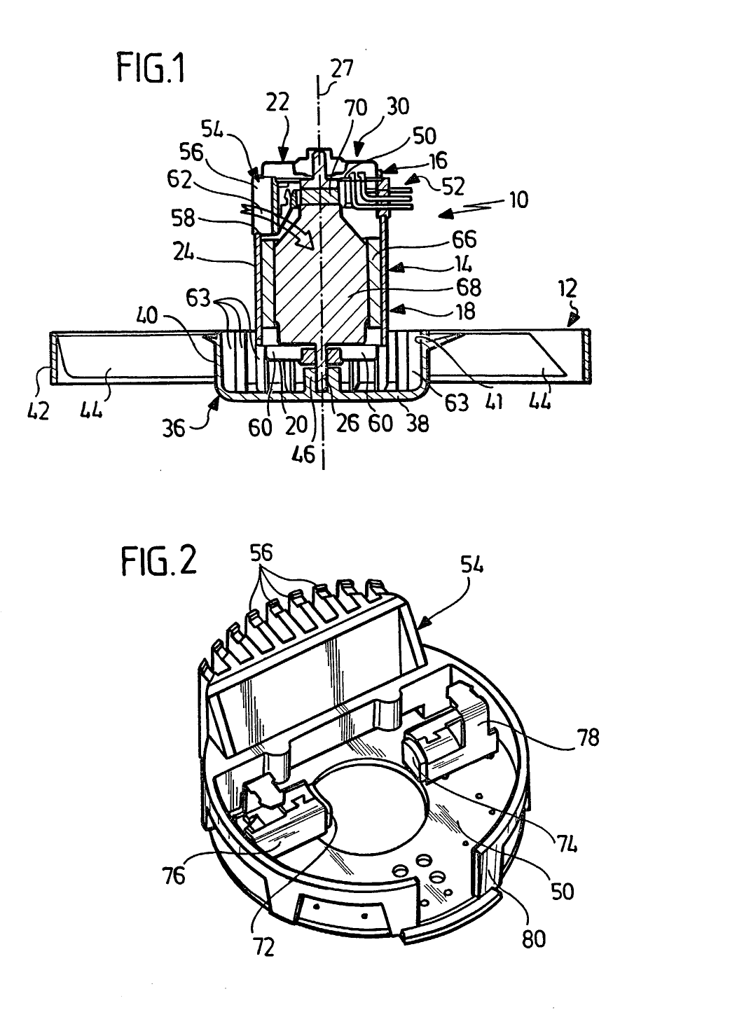

FIG. 1 shows diagrammatically an electric fan generally designated by reference numeral 10, for use, in particular, in motor vehicles, which is positioned on a radiator unit inside the engine compartment so as to allow a flow of air generated by the fan 10 to be directed onto the radiator unit. The electric fan 10 comprises a fan wheel 12 and a drive motor 14, which will be referred to hereinafter as fan motor. Also provided is an electronic control unit 16 which is arranged together with the fan motor 14 in a substantially cylindrical housing 18. The housing 18 has a front bearing cover 20 facing the fan wheel 12 and a rear bearing cover 22 facing away from the fan wheel 12, which close off at the end faces a housing jacket 24 enclosing the control unit 16 and the fan motor 14 in a circumferential direction. The front bearing cover 20 and the rear bearing cover 22 each form a bearing for a motor shaft 26 protruding from the front bearing cover 20 and defining a longitudinal axis 27 of the fan motor 14.

The fan motor 14 and the control unit 16 which are held jointly inside the housing 18 form an electric drive 30 in the form of a compact constructional unit for driving the fan wheel 12.

The fan wheel 12 is designed as an axial fan and comprises a fan pot 36 engaging over the front bearing cover 20 of the housing 18. The fan pot 36 of substantially U-shaped design comprises a bottom wall 38 oriented transversely to the longitudinal axis 27 and a side wall 40 in the form of a cylinder jacket oriented coaxially with the longitudinal axis 27 and integrally connected to the bottom wall 38. At a radial spacing from the side wall 40, the fan wheel 12 has an outer ring 42, and several radially oriented fan blades 44 extend in the usual way between the side wall 40 and the outer ring 42.

Facing the front bearing cover 20, a sleeve 46 is formed on the bottom wall 38 of the fan pot 36, via which the fan wheel 12 is rotationally fixedly connected to the fan motor 14 so that the fan wheel 12 is rotationally drivable about the longitudinal axis 27.

The electric control unit arranged inside the housing 18 is provided for power-controlled operation of the fan motor 12. As is apparent, in particular, from FIG. 2, the control unit 16 comprises a circular ring-shaped printed circuit board 50 which is held adjacent to the rear bearing cover 22 and in parallel alignment therewith inside the housing 18 and surrounds the motor shaft 26 in a circumferential direction. The printed circuit board 50 receives in a manner known per se and, therefore, not shown in the drawings an electronic module comprising a large number of electronic components which are held on the printed circuit board 50 and are electrically connected to one another via electric conductor paths. With a view to more clarity, the electronic components are not shown in FIG. 2. The control unit 16 comprises in the usual way an electronic control device for generating pulse-width-modulated control signals and an electronic power device with several FET output stage switches, as known, for example, from German laid-open print DE 197 02 949 A1. The electronic components held on the printed circuit board 50 are electrically connected via connection lines 52 led out of the housing 18 to a power supply and to a control device, for example, a central engine management system of a motor vehicle.

The printed circuit board 50 is held inside the housing 18 via a metallic heat sink 54 which, in turn, is secured to the rear bearing cover 22 and comprises a plurality of cooling fins 56 and a holding ring 80 enclosing the printed circuit board 50. The cooling fins pass through an air inlet opening 58 formed in the housing jacket 24 and arranged adjacent to the rear bearing cover 22. Corresponding air outlet openings 60 are provided on the front bearing cover 20 so that a flow of cooling air 62 can be conveyed through the housing 18 via the air inlet opening 58 and the air outlet opening 60.

Several lamellae 63 oriented perpendicularly to the side wall 40 and spaced equidistantly from one another are provided on the inner side 41 of the side wall 40 of the fan pot 36 facing the sleeve 46 to generate the flow of cooling air 62. When the fan wheel 12 is set in rotational motion by the fan motor 14, the air inside the fan pot 36 is set in rotation owing to the lamellae 63 oriented transversely to the direction of rotation of the fan wheel 12. This rotational motion, in turn, causes a centrifugal force to act upon the air, with the result that the air is whirled outwards at an incline. A negative pressure is thus generated inside the fan pot 36 in the area of the air outlet openings 60 arranged on the front bearing cover 20, and, as a result of this negative pressure, air is drawn in by suction through the air inlet opening 58. The flow of cooling air 62 is thus formed inside the housing 18 of the electric drive 30, and, starting from the air inlet opening 58, it is first oriented substantially radially in relation to the longitudinal axis 27 and forms a radial flow section adjacent to the printed circuit board 50. In the direction of the front bearing cover 20, the flow of cooling air 62 then passes over into a substantially axially oriented flow section and passes out of the housing 18 through the air outlet openings 60.

The cooling fins 56 of the heat sink 54 are arranged inside the air inlet opening 58 and the flow of cooling air 62 therefore flows through them. This results in effective cooling of the heat sink 54 and the printed circuit board 50 secured thereto. The fan motor 14 is also effectively cooled, as the flow of cooling air 62 acts upon it virtually along its entire length.

The fan motor 14 is designed as a commutator motor. It comprises in the usual way a stator 66 secured to the housing 18 and an armature 68 rotatably mounted on the bearing covers 20 and 22. There is held in the usual way on the armature 68 at the level of the printed circuit board 50 a commutator 70, shown only diagrammatically in the drawings, with two carbon brushes 72, 74 rubbing thereon. The latter are held on the printed circuit board 50. To this end, there are fixed on the printed circuit board 50 two carbon brush holders 76, 78 which each receive a carbon brush 72 and 74, respectively. The carbon brush holders 76, 78 form a housing in which the carbon brushes 72 and 74, respectively, are held for displacement in the direction towards the commutator 70.

As is apparent from FIG. 2, the printed circuit board 50 is surrounded in a circumferential direction by the holding ring 80, which is integrally connected to the cooling fins 56 and to which the printed circuit board 50 is secured. The holding ring 80 forms part of the heat sink 54 and is immediately adjacent to the carbon brush holders 76 and 78. An optimum heat dissipation from the carbon brushes 72 and 74 via the carbon brush holders 76 and 78, respectively, and the printed circuit board 50 to the heat sink 54 is thereby ensured. As a result of this, the carbon brushes 72 and 74 have a relatively low temperature during operation of the electric drive 30, which substantially prolongs the service life of the electric drive.

The carbon brushes 72 and 74 are connected via copper lines known per se, not shown in the drawings, to the electronic power device of the control unit 16. Owing to the arrangement of the carbon brushes 72 and 74 on the printed circuit board 50,. the electric connection lines can be kept very short, so that a very good overall efficiency of the electric drive 30 is achieved and the emission and reception of electromagnetic interference is kept low.

As is apparent from FIG. 2, the heat sink 54 forms in combination with the printed circuit board 50 and the carbon brushes 72, 74 with associated carbon brush holders 76, 78 a constructional unit for independent handling, thereby simplifying assembly of the electric drive 30.

1. Electric drive, in particular, for a fan of a motor vehicle, comprising an electric drive motor and an electronic control unit for controlling said drive motor, said drive motor comprising a commutator and power supply devices rubbing on said commutator, and said control unit comprising a printed circuit board, said drive motor and said control unit being arranged in a common housing, and said power supply devices being held on said printed circuit board.

2. Electric drive in accordance with claim 1, wherein the control unit comprises a heat sink which is thermally coupled with the power supply devices.

3. Electric drive in accordance with claim 2, wherein the heat sink comprises several cooling elements arranged at an air vent of the housing, and a holding element to which the printed circuit board is secured.

4. Electric drive in accordance with claim 3, wherein the holding element surrounds the printed circuit board in the shape of a ring.

5. Electric drive in accordance with claim 1, wherein the printed circuit board surrounds the motor shaft in a circumferential direction.

6. Electric drive in accordance with claim 5, wherein the printed circuit board is of approximately circular ring-shaped design.

7. Electric drive in accordance with claim 1, wherein the printed circuit board forms together with the power supply devices and the heat sink a constructional unit designed for independent handling.

8. Electric drive in accordance with claim 1, wherein the power supply devices are designed as carbon brushes.

9. Electric drive in accordance with claim 8, wherein the carbon brushes are each displaceably held on a carbon brush holder secured to the printed circuit board.

10. Electric fan, in particular, for a motor vehicle, comprising an electric drive in accordance with claim 1 and a fan wheel drivable by the drive motor of the electric drive.

11. Electric fan in accordance with claim 10, wherein a flow of cooling air is generatable through the housing of the electric drive by the fan wheel and acts upon the printed circuit board and the power supply devices held thereon.
